(19) United States
(12) Patent Application Publication
(10) Pub. No.: US 2010/0271394 A1
(43) Pub. Date: Oct. 28, 2010

(54) SYSTEM AND METHOD FOR MERGING VIRTUAL REALITY AND REALITY TO PROVIDE AN ENHANCED SENSORY EXPERIENCE

(76) Inventor: Terrence Dashon Howard, Plymouth Meeting, PA (US)

Correspondence Address: STROOCK & STROOCK & LAVAN LLP, 180 MAIDEN LANE, NEW YORK, NY, 10038, US

(21) Appl. No.: 12/765,485

(22) Filed: Apr. 22, 2010

Related U.S. Application Data
(60) Provisional application No. 61/171,562, filed on Apr. 22, 2009.

(51) Int. Cl. G09G 5/377

(52) U.S. Cl. 345/633

(57) ABSTRACT

A system and method of merging virtual reality sensory detail from a remote site into a room environment at a local site. The system preferably includes at least one image server; a plurality of image collection devices; a display system, comprising display devices, a control unit, digital processor and a viewer position detector. The control unit preferably receives the viewer position information and transmits instructions to the digital processor. The digital processor preferably processes source data representing an aggregated field of view from the image capturing devices in accordance with the instructions received from the control unit and outputs refined data representing a desired display view to be displayed on the one or more display devices wherein the viewer position detector dynamically determines the position of the viewer in the room environment and changes the desired display view corresponding to position changes of the viewer.

### CROSS-REFERENCE TO RELATED APPLICATION

This application claims the benefit of U.S. Provisional Application Ser. No. 61/171,562 filed Apr. 22, 2009, entitled “SYSTEM AND METHOD FOR MERGING VIRTUAL REALITY AND REALITY TO PROVIDE AN ENHANCED SENSORY EXPERIENCE”, the entire disclosure of which is incorporated by reference herein.

### BACKGROUND OF THE INVENTION

1. Field of the Invention

The present invention relates generally to the capture, transmission, and display of remote images and, more particularly, to systems and methods for enhancing an environment using such images.

2. Background of the Invention

Most people spend much (if not most) of their life in a common environment—a room with windows. Though rooms come in a myriad variety of styles, shapes and décor—they share several common traits. For the most part, the interior environment of any particular room is relatively stagnant from day to day. Furniture and accessories tend to remain in the same location from week to week or even year to year. Many rooms contain windows on the walls or ceilings (skylights) that allow a view or glimpse of the environment outside the window. Since the remainder of the room is often static or stagnant, the “window view” is often the most dynamic component of a room's environment. Studies have shown that even when an occupant is not consciously focused on what is happening “outside,” the view from a room's window can have profound influence on an occupant's mood, productivity, sense of security and contentment. Some have even suggested that the effect of a limited “Zen view” may be greater than a persistent all encompassing view.

The ability to enhance an occupant's experience in a room significantly by controlling the view to the outside environment depends to a very large extent on the extent to which the “virtual reality” is indistinguishable from the “reality” within the room. Accordingly, aspects of the invention pertain to tools and systems that merge the virtual reality components (e.g., windows) into the room environment in a way that is not easily perceived (if at all) by the occupants of the room.

### BRIEF SUMMARY OF THE INVENTION

The system according to one embodiment of the present invention allows the user to experience “virtual reality” merged seamlessly into the familiar “real world” environment of a room with windows.

The system is applicable to existing structures and there is no need for users to wear special equipment (eye goggles or other accessories), though the use of additional equipment is an optional feature of this invention.

One aspect of the present invention is the recognition that it is possible to enhance an occupant's experience in a room significantly by controlling the view to the outside environment.

At the highest level, the system relies largely on visual and audio stimuli to create the virtual reality, such as one or more display screens and speakers, for example. However; aroma generators and haptic interfaces could also be used to simulate smell and touch.

In addition, the system preferably includes location sensing equipment for determining at least the location of room occupants. The equipment preferably is able to sense or determine the size, identity, preferences and orientation of occupants. The currently preferred hardware to achieve this functionality is an infrared detection system that stores an image (which can be periodically refreshed) of the room in an unoccupied state and monitors (via an array of sensors) the room for changes in state. This system could also provide a valuable security and alarm system function by detecting fire (through heat) and/or intrusion. Alternative position determination and monitoring technologies could be employed, including, for example, sensors for detecting RFID tags and other ID systems worn by users.

An important aspect of the present invention is the integration of the displays into windows locations or simulated window locations. Architectural or interior design finishes may be used to enhance the integration of the displays into the room in a way that makes the displays difficult to distinguish from ordinary windows. Preferably two or more display windows are provided in a room to provide an enhanced experience, but this is not required.

Though various display technologies could be used, the currently preferred technology is an organic light emitting diode display (OLED's), which may be rendered transparent (to allow natural light to pass through) or provided on a very light substrate suitable for this application.

Other displays can be used as appropriate. The physical size and configuration of the display will dictate the hardware and architectural or interior design finishes needed to blend the display into the room in a way that makes the display difficult to distinguish from ordinary windows. If, as preferred, the display covers a window, the back (outward facing) surface of the display may be provided with solar panels to provide electricity to the display. Speakers and other sensory output devices are preferably provided on or proximate to the display.

The displays of the present invention are preferable “touch screen” displays that are linked to a computer for image generation so that the user may personalize or enhance the image displayed on the display by, for example, adding a waterfall or clouds to the vista being displayed.

Because the system of the present invention integrates a wide variety of technology, it is anticipated that the underlying technologies (e.g., display technology, sensing technology, sensory data reproduction technology, solar power supply technology, imaging (camera, lens and image processing) technology) will improve over time. Accordingly, an important aspect of the present invention is that the technology components are upgradeable/replaceable as subsystem units or modules without replacing the entire system.

In accordance with an important aspect of the present invention, the images displayed on the display(s) are gathered from an array of cameras positioned in an optimal setting. The setting may range from the current or past view from the immediate exterior of the room to a remote (exotic, far away) location (e.g., the beach in Hawaii, the glaciers in Alaska or a desert). When the display is displaying the current or past view from the immediate exterior of the room, the display shows what one would see (or would have seen in the past) if the display were, in fact, a window. This image may be gathered from a camera located at or proximate the back of the display shown live or from a recording. When the image is from a remote location, the image is received as streaming data from one of a plurality of image collection locations that are provided according to the present invention.

In accordance with the present invention, each image collection location is equipped with sufficient image capture (e.g., camera) equipment to allow users at remote locations to gain a “window view” of the location from a wide variety of perspectives—effectively mimicking the variety of perspectives that a room occupant has through a window as the occupant moves about the room. Since windows can be aligned in any direction it is preferable to be able to provide views associated with at least the four directions (e.g., the cardinal directions north, east, south and west) and the intermediate directions: north-east (NE), north-west (NW), south-west (SW), and south-east (SE).

In the currently preferred embodiment, image capture can be achieved using 3D camera capture with two cameras in each of four directions and an additional pair of cameras for the vertical direction.

To achieve optimal performance, a variety of lens types may be used at the image capture location. Thus, for example, lenses may provide telephoto, enhance the area, night vision, Frazier Lens, heat sensing lens and the like capabilities. The configuration of the lens is preferably modeled according to the construction of a bee's eye—collecting information similar to the function of the optic nerve, e.g., cones, convex, concave shaped lens housed within a sphere or spherical shape.

When fully realized, the system will preferably include cameras of all kinds pointed in every direction possible to allow the viewer to see a perfectly recreated world from every window. All collected images will be stored in a computer and stitched together to create a complete 360 degree image. The computer processing of the collected images can occur fully or partially on site or fully or partially at an image server site. The image data (raw, partially processed or fully processed) collected at each of the plurality of image collection areas is streamed (e.g., by cable or satellite) to one of more image servers. The image servers route image feeds to room displays as requested. Importantly, each perspective view may be simulcast (simultaneously routed) to many different locations. In this way the hardware infrastructure needed to capture multiple high quality image perspectives from each image collection location may be leveraged.

Thus, the system of the present invention preferably comprises a plurality of rooms, at least one image server and a plurality of image collection locations.

Each room has at least one (preferably more) window display, occupant position sensing equipment (infra red, RFID etc.) and a display controller (control box) for receiving user preferences/requests, receiving input from the position sensing equipment, determining a specific image stream to be requested for each display based on the occupant's location, requesting the image stream from an image server, and directing the image stream to the appropriate display. The image stream may include an audio data stream and other sensory data as well. Non-visual sensory data is not as position-sensitive as visual data, so this data may be position-insensitive for each image collection location.

The image server receives one of more streams of image data from each of the plurality of image collection locations. To the extent necessary (i.e., if not completed at the image collection location) the image streams are processed to provide a complete set of image data so that an image stream associated with a plurality of perspectives may be streamed on demand to the plurality of rooms. Thus, for example, if an image collecting location is in Hawaii, the image server will be able to provide a plurality of image streams so that a display in a room may provide an occupant a perspective that is accurately associated with the occupant's position in relation the window display. Therefore if a room has window displays on adjacent walls, the respective displays will use different video streams collected from the same image collection location to accurately depict the various perspectives.

Each image collection location includes multiple image capture devices to capture the necessary image data to provide all desired perspectives.

In use, the window displays may replace existing windows and be moved out of the way of the window as desired. When the window displays are deployed, the displays will display an image according to the user's selection or preferences (as previously recorded or stored on an ID tag worn by the user). The controller continually monitors the position of occupants in the room and adjusts the image stream being displayed to correspond to the perspective of the occupant nearest the display. Because the controller is able to continually monitor the room it is also capable of providing a security/occupant safety function as an alarm system in case of fire or intrusion, for example. As noted, the user may alter/enhance the image being displayed by, for example, adding features (a rainbow, clouds) to the vista being displayed.

The system may have indoor and outdoor recording capabilities. Therefore, it could function as a home security system or home recording device by recording the area surrounding the window where the unit is installed. Similarly, the unit could record the area surrounding the exterior of the building (outside of the window). The unit may have motion detection that can be turned on or off. The user may further have the ability to control where and when the unit is recording and access the recording remotely (through, for example, an internet-based remote access application, such as Citrix™).

### BRIEF DESCRIPTION OF THE DRAWINGS

FIG. 1 is a schematic diagram of various components in a system for capturing, transmitting, receiving, and displaying images in accordance with an embodiment of the present invention.

FIG. 2A is a schematic diagram of a local site configured for viewing images in accordance with the present invention.

FIG. 2B is a perspective view of another local site configured for viewing images in accordance with the present invention.

FIG. 3 is a schematic diagram of a conventional multi-camera image collection device.

FIG. 4 is a schematic diagram showing a 360-degree field of view captured by a conventional multi-camera image collection device.

### DETAILED DESCRIPTION OF CERTAIN EMBODIMENTS

The present invention relates generally to systems and methods for locally displaying images recorded or transmitted from a remote location. Various embodiments of the present invention will be described herein, including several specific configurations and alternative components, all of which, and combinations thereof, would be recognized by one skilled in the art as within the scope of the invention as defined in the appended claims. As used herein, the term “local” refers to the location or site at which a display system is installed, and the term “remote” refers to the location or site from which images are captured and transmitted.

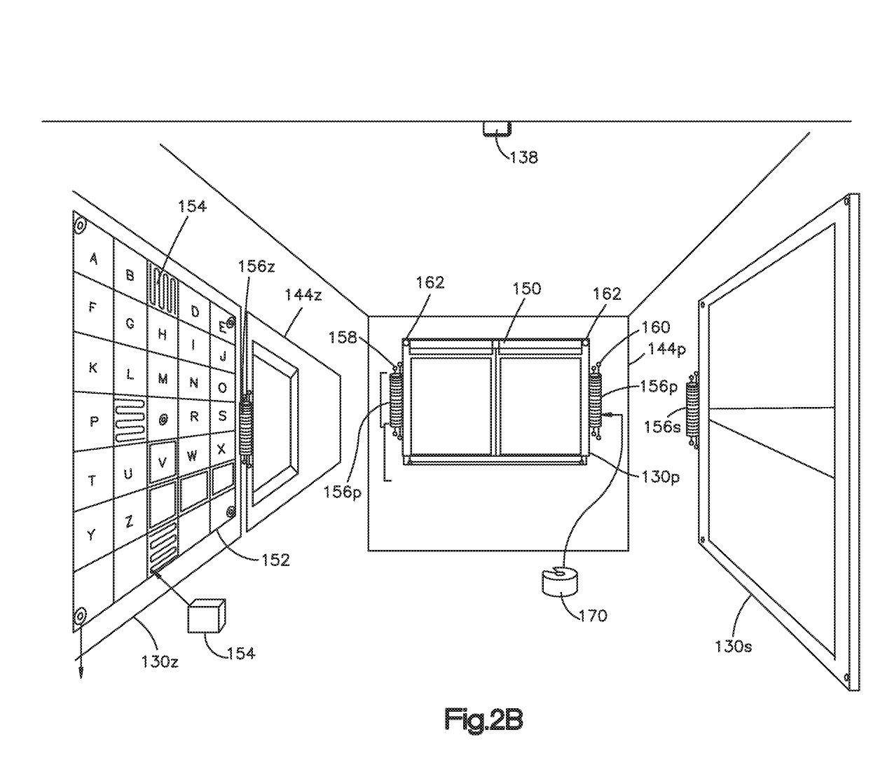

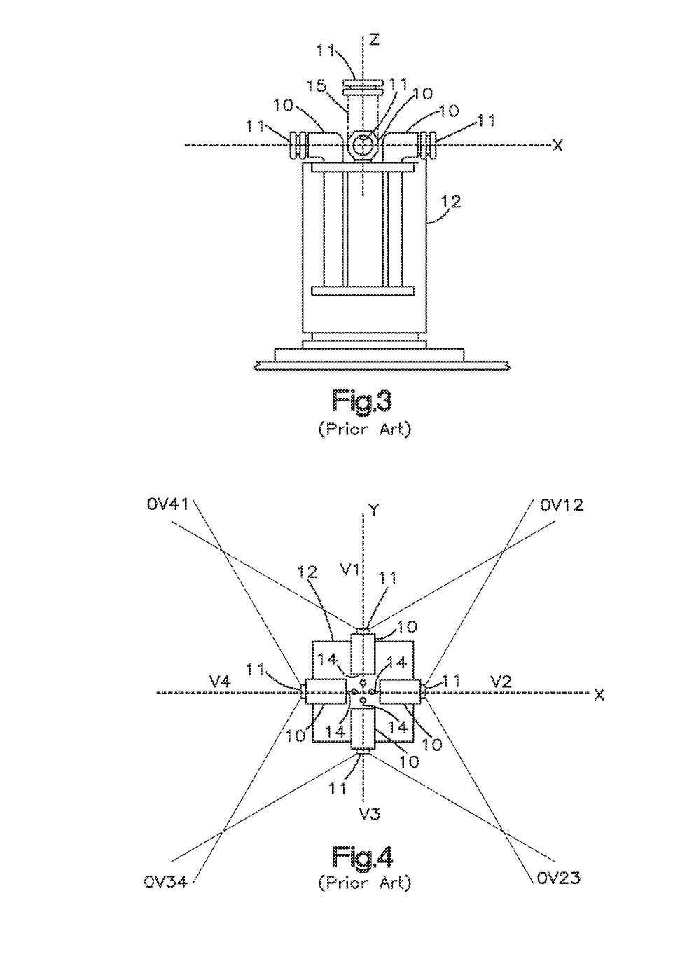

In an embodiment of the invention, images from the remote location may be captured by a single or multi-camera panoramic/panospheric imaging system. Examples of suitable imaging systems are described in U.S. Pat. Nos. 5,130,794, 5,185,667, 5,657,073 and 6,084,979, each of which is incorporated by reference herein in its entirety. FIGS. 3 and 4 depict a multi-camera imaging system as described in U.S. Pat. No. 5,657,073, which is capable of capturing at least a panospheric field of view. One of skill in the art will appreciate that other forms of image capture may be applied as is generally known in the art. A single camera imaging system may be used, provided such a camera has a field of view sufficient to accommodate the particular display application, including single cameras having a field of view as large as full spherical coverage or as small as desired. One of skill in the art will appreciate that other image capture devices may be used to capture a desired field of view in accordance with the present invention.

The images may be captured in any suitable format and stored as electronic information, which information will be referred to herein as “source data.” In an embodiment, the source data represents a hemispherical (or panospherical) field of view of the remote location captured by a camera configuration suitable for such a purpose. The hemispherical field of view may be captured by a plurality of cameras each oriented in a different angular direction with respect to a horizontal x-y plane shown in FIGS. 3 and 4, in addition to one or more cameras oriented in a vertical direction (i.e., along a vertical z-axis as shown in FIG. 3). As shown in FIG. 4, four cameras are oriented in equal angular intervals in the x-y plane to capture an entire 360 degree panoramic field of view. Any areas of overlap between the respective images captured by adjacent cameras may be eliminated by suitable digital processing, such as that described in U.S. Pat. No. 5,657,073 (elimination of redundant pixels). Digital processing may likewise be used to reduce any distortion, caused by the camera lens, such as processing described in U.S. Pat. No. 5,185,667 (eliminating distortion caused by a fish-eye lens).

A fifth camera may be provided that is oriented in a vertical direction (positive z-axis in FIG. 3) in order to complete the hemispherical field of view, if such a view is not already sufficiently provided for by the cameras in the x-y plane.

The camera lenses may be standard lenses or, if desired, may be any suitable configuration of special purpose lenses such as, for example, bee's eye, cones, convex, concave, Frazier, wide angle, fish-eye, or telephoto lenses. One of skill in the art will appreciate that the number of cameras used may be increased or decreased, and their specific orientation and configuration may be modified, depending on the particular lens configuration used and the desired field of view.

A bee's eye lens may be particularly applicable to the present invention due to its increased precision and distance-determining capabilities. A bee's eye has a very complex structure, with over 8,500 hexagonal built-in lenses, each unit being orientated in a slightly different direction, the final image will look like a miniature mosaic. In this embodiment, the lens of the present invention mimics the bee's eye—using an artificial eye that resembles a dome. Like a bee's eye, this miniature structure is made of thousands of minuscule lenses, every one of them guiding the light into a channel containing light-sensitive cells which yield a composite image. One such lens structure is currently the subject of a project financed by Defense Advanced Research Projects Agency (DARPA). In addition, researchers at the University of Osaka have developed an ultrathin camera that can determine the distance between objects in a scene and pick out color and structural features. This camera is based on biological imaging systems—especially the compound eyes of insects—for the design blueprint. The technology, called TOMBO (Thin Observation Module by Bound Optics), is actually a collection of nine small lenses and software that analyzes the scene by mimicking the process that insects use to recognize the position, shape, and color of objects. The TOMBO's hardware fits into a tiny box the size of a shirt button. The basic idea behind the technology is that multiple lenses capture information about a scene from slightly different angles, just as our eyes look at an object from two distinct points of view. The relative angle at which a person sees an object depends on how far away the object is from her eyes. Additionally, the color and shape of an object differ slightly based on which eye is looking at it and where a light source is. Essentially, our brains compare the input from our two eyes to determine distance, color, and shape, among other features. The same principle is applied to the image-recognition algorithms. The software separates the nine small images, removes shading, compensates for distortion in the images, and remaps the pixels into a single two-dimensional image The accumulated error in the remapping process, which is effectively the differences between the images from each lens, can be used to extract the object's distance, color, and shape, allowing a picture to be recreated in full 3-D, as well as employed for object recognition.

In another embodiment, the source data represents two separately, but simultaneously, captured fields of view suitable for use in a display device configured for a three-dimensional viewing experience. This may be accomplished by stereoscopy by utilizing a pair of cameras in each direction rather than a single camera. In this manner, two separate composite hemispherical fields of view may be created: one from the aggregation of the left-hand cameras in each pair, and one from the aggregation of the right-hand cameras in each pair. The two views may be processed in accordance with now-known or later-developed three-dimensional display technology in order to present a user with the overlaid stereoscopic views, thereby achieving a three-dimensional effect. The number and orientation of the cameras sufficient to enable 3D images may depend upon the scopes of the respective lenses and their panoramic potential. The cameras preferably provide at least a full hemispheric field of view at the image collection (capture) location, but may of course be greater or smaller depending upon the intended range of options to be provided for display at the local site.

In some embodiments, image processing or display in addition to a passive user device (e.g., 3D glasses) may be employed in order to achieve the three-dimensional effect. In other embodiments, image processing or display and/or an active device (e.g., active 3D glasses or headset) may be employed. In still other embodiments, image processing and/or specialized display devices may be utilized to achieve a three-dimensional effect without any aid worn by a user. Examples of suitable three-dimensional processing and display technology include linear polarization, circular polarization, liquid crystal shutter glasses, interference filter technology, complementary color anaglyphs (e.g., red-cyan, blue-amber), autostereoscopy, etc.

In accordance with further embodiments of the present invention, source data may represent any desired field of view of the remote location. For example, the source data may represent a 360-degree panoramic view (for example, by only using the four cameras in the x-y plane in FIG. 4) or a particular portion thereof (for example, a limited 180-degree view, using only one or two cameras). In other embodiments, the source data represents views captured by vision-enhancement cameras, such as infrared, night-vision, heat sensing, etc. A remote location may further be equipped with one or more different types of image acquisition means described above so that multiple types of source data can be created with the captured images. To the extent possible, the different types of image acquisition means may be integrated into a single camera system.

In an alternative embodiment, the source data may further comprise audio and/or atmospheric data. Microphones or other sound detecting mechanisms may be disposed at the remote site for acquisition of audio signals for transmission to the local site. Atmospheric sensors (e.g., thermometers, barometers, etc.) may also be provided at the remote site to help in reconstructing the remote environment at the local site.

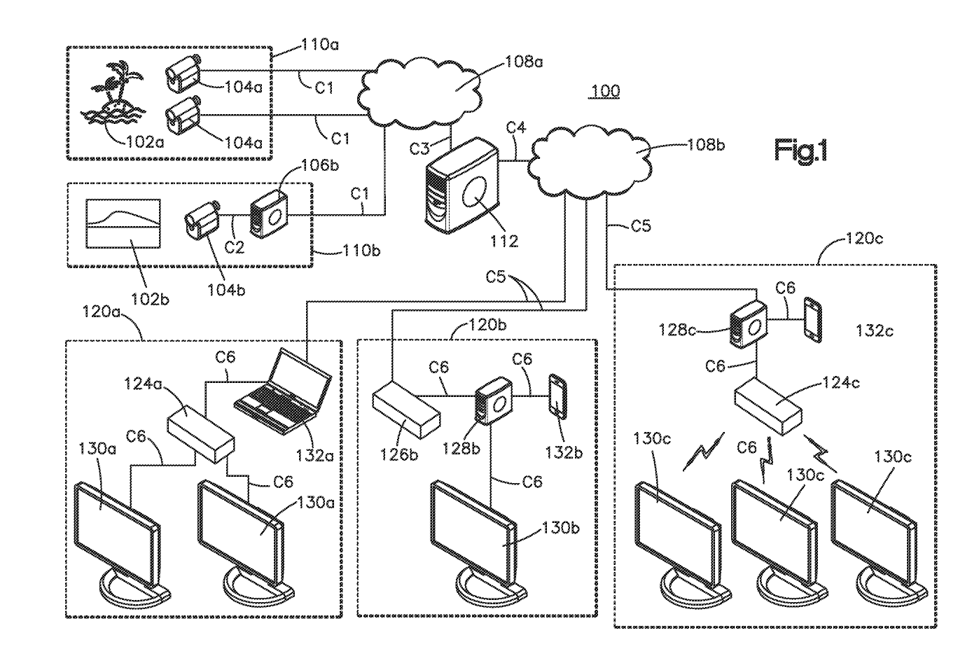

FIG. 1 shows a schematic view of hardware and network components in an exemplary system 100 in accordance with one embodiment of the present invention. The system 100 shown in FIG. 1 is merely illustrative and it will be recognized that various modifications and alterations may be made within the scope of the present invention.

As shown in FIG. 1, two remote sites 110a and 110b serve as a source for images 102a and 102b. Remote site 110a may be, for example, a tropical island. Two cameras 104a are shown as capturing an image 102a at the site 110a. While only two cameras 104a are shown, it is appreciated that any number of cameras may be situated at the location 110a (such as five cameras, as described above) in order to achieve a desired field of view 102a. The field of view 102a may be as large as a panospheric view or even as large as a complete spherical view, or may be as small as desired. The cameras 104a are preferably digital cameras but may alternatively be analog cameras. The data captured by the cameras 104a is the source data that represents the captured field of view 102a, which may then be transmitted via communication lines C1 to an Internet destination 108a or to an off-site server 112 via satellite and/or fiber-optic communications 108a, C3 (or any other communication means 108a, C3). As shown, data flows directly from the image capture devices 104a to external components, in which case such external components such as server 112 may be configured to process the received images to construct an aggregate field of view by stitching the images from respective cameras and reducing distortion.

At a second remote site 110b, an on-site processor 106b is provided for constructing the field of view data before transmitting to external components. Although only one camera 104b is shown, it is appreciated that any number of cameras may be provided at site 110b to capture the desired field of view. The camera(s) 104b may transmit captured images via communication line C2 (which may be wired or wireless) to processor 106b for aggregation and distortion reduction. The processor 106b then transmits this data, which is the source data representative of the desired field of view of the scene 102b, over communication line C1 to the internet or to the off-site server 112 through communication means 108a and C3.

The source data comprising the processed images captured at the remote location 110 may be transmitted real-time or quasi-real-time to the server 112 and eventually to local locations 120a, 120b, 120c to be displayed. Images are preferably captured in a digital format (either directly from a digital camera or after conversion from an analog camera) and transmitted by any suitable transmission means, for example by radio frequency (RF), cellular, satellite, wireless, or wired transmissions. Temporary or permanent electronic storage may be utilized at the camera site to provide any desired data buffering and/or processing before transmitting the source data to the local site. In other embodiments, the source data may be transmitted in analog format by any suitable transmission means.

Alternatively or in addition to transmitting images real- or quasi-real-time, the images captured at the remote location 110 may be stored at the source of the image 106b or at local sites 120 where the image is to be displayed. Further, the captured images may be stored at a third-party location, for example, at a central server 112 maintained by a service provider. The data is preferably stored digitally, although it is appreciated that analog storage is within the scope of the invention. In the case of storing the image data at a location other than the source of the images, the data may be transmitted to the storage site 112 and, in turn, to the local site 120 by any suitable transmission means C1, C2, C3, C4, C5, for example by radio frequency (RF), cellular, satellite, wireless, or wired transmissions.

In other embodiments the source data may comprise a plurality of separate video feeds, each from a respective one of the cameras situated at the remote site. In this manner, processing of the captured images may be reduced or eliminated (by not having to stitch together the images) and the source data may be transmitted to the local site in a raw or near-raw form for display. Each video feed can be displayed by a designated display device or devices representing a corresponding direction (e.g., one display device may display the video feed from a camera capturing a north view at the remote site and one display device may display the video feed from a camera capturing an east view at the remote site). Such an embodiment may reduce the costs, power consumption, and time delay associated with data processing.

As shown in FIG. 1, three separate local sites 120a, 120b, 120c (generically referred to as reference 120) are illustrated, each with different component configurations in accordance with the present invention. The three local sites illustrated in FIG. 1 are not the only configurations contemplated by the present invention, they are merely exemplary, and one of skill in the art will appreciate that the various components can be rearranged, added, or omitted as desired in a given application.

The source data, which is generated by the processing of the captured images and transmitted from remote site 110, is ultimately received at the local site 120, where further processing may be carried out if desired by a processor 126, 128. The resulting data is then displayed on one or more display devices 130 (the processors 126, 128, display devices 130, and other associated components collectively referred to as a “display system”).

In an embodiment of the invention, the basic functions of the display system are to receive the source data, process and/or configure the data to be displayed in accordance with a programmed scheme, and to display the processed and/or configured source data on one or more display devices 130. As used herein, the term “refined data” refers to the electronic data that represents the images or content transmitted to the one or more display devices for display, after any processing and/or configuring by the various systems involved. The refined data essentially represents the images that are actually displayed on the display devices. Although the word “refined” is used, it will be appreciated that the term includes source data that has not undergone any processing and is transmitted and displayed in a raw or nearly raw form at the local site.

In one exemplary local site 120a shown in FIG. 1, the source data is received via communication line C5 (e.g., over the internet or from direct connection to central server 112) by an integrated processor and user interface device 122a. The device 122a may similarly have an integrated modem or other receiver device for receipt of the source data over line C5. A laptop computer is shown in FIG. 1, but it will be appreciated that the integrated processor and user interface can take any form, such as a desktop computer or a specialized console configured specifically for use in the present invention. The integrated processor/interface device 122a then processes the source data for display at the site 120a based on the known configuration of the display devices 130a to produce the refined data, which may comprise separate signal channels for each of the display devices 130a. The refined data is then transmitted via communication lines C6 to a router 124a, which then distributes the corresponding signal channels to the appropriate display device 130a. It is appreciated that communication lines C6, which are shown in all local sites 120a-c in FIG. 1, may comprise any known transmission mechanism, such as fiber-optics, ethernet cable, coaxial cable, Wi-Fi™, Bluetooth™, RF signals, or any other suitable wired or wireless technology. To the extent that common reference characters exist in other local sites 120b, 120c shown in FIG. 1 (i.e., reference characters having common numeric stems are considered to be common characters), the discussion above is equally applicable to those sites.

References herein to computers, computer systems, servers or processors refer to computer processing units, such as computer servers, personal computers or workstations. Although not depicted in the figures, the computers computer systems, servers or processors referenced herein generally include such art recognized components as are ordinarily found in such computer systems, including but not limited to processors, RAM, ROM, hard disks or other computer readable mediums, clocks, hardware drivers, associated storage, and the like. Furthermore, each of the computer systems described herein may include a network connection even if one is not shown. The network connection may be a gateway interface to the Internet or any other communications network through which the systems can communicate with other systems and user devices. The network connection may connect to the communications network through use of a conventional modem (at any known or later developed baud rate), an open line connection (e.g., digital subscriber lines or cable connections), satellite receivers/transmitters, wireless communication receivers/transmitters, or any other network connection device as known in the art now or in the future.

In a second exemplary local site 120b, the display system is distinguished from that in the first local site 120a in that there is no integrated processor and interface unit and in that there is only one display device 130b. Instead of an integrated process/interface unit, the local site 120b comprises a modem or other suitable receiver device 126b to receive the source data, a data processor 128, and a user interface device 132b. Since there is only one display device to receive the refined data after processing, a router may optionally be omitted. Communications are similarly achieved over lines C6, which may be any suitable mechanism for transmission of signals. The user interface 132b may be any suitable device, such as a touch screen, keypad, buttons, or knobs, and may be mounted at any desired location in the local site 120b, including directly onto or within the display device 130b or processor 128b.

In a third exemplary local site 120c, a processor 128c receives the source data from communication line C5 by means of an integrated modem or other receiver device. The processor 128c processes the source data to result in refined data, and preferably by creating separate signal channels for each of the display devices 130c (three shown in FIG. 1). The user interface 132c, which may be separate or integral with the processor 128c or display devices 130 allows a user to input particular specifications and/or preferences in order to customize the display. Upon processing, the refined data is transmitted from the processor 128c to the router 124c for distribution to the respective display devices 130c. The third exemplary local site 120c depicts the router as a wireless router that transmits the refined data to each of the display devices 130c, although one of skill in the art will appreciate that any suitable means of transmission may be utilized.

The one or more display devices 130 may include, for example, organic light emitting diode display (OLED), LCD flat panel monitors, plasma flat panel monitors, CRT monitors, projectors (and projection surface; e.g., a screen), televisions, computer monitors, or the like, and any combination thereof. As noted above, the preferred display device is an OLED, which typically operates as provided below, although other methods and systems of OLED may be used and are within the scope of the invention.

Organic light emitting diode displays (OLED's) typically consist of the following parts:
Substrate (clear plastic, glass, foil)—The substrate supports the OLED.
Anode (transparent)—The anode removes electrons (adds electron “holes”) when a current flows through the device.
Organic layers—These layers are made of organic molecules or polymers.
Conducting layer—This layer is made of organic plastic molecules that transport “holes” from the anode. One conducting polymer used in OLEDs is polyaniline.
Emissive layer—This layer is made of organic plastic molecules (different ones from the conducting layer) that transport electrons from the cathode; this is where light is made. One polymer used in the emissive layer is polyfluorene.
Cathode (may or may not be transparent depending on the type of OLED)
The cathode injects electrons when a current flows through the device.

The process of operation of the OLED is as follows: The battery or power supply of the device containing the OLED applies a voltage across the OLED. An electrical current flows from the cathode to the anode through the organic layers (an electrical current is a flow of electrons). The cathode gives electrons to the emissive layer of organic molecules. The anode removes electrons from the conductive layer of organic molecules. (This is the equivalent to giving electron holes to the conductive layer.) At the boundary between the emissive and the conductive layers, electrons find electron holes. When an electron finds an electron hole, the electron fills the hole (it falls into an energy level of the atom that is missing an electron). When this happens, the electron gives up energy in the form of a photon of light. The OLED emits light. The color of the light depends on the type of organic molecule in the emissive layer. Manufacturers place several types of organic films on the same OLED to make color displays. The intensity or brightness of the light depends on the amount of electrical current applied; the more current, the brighter the light.

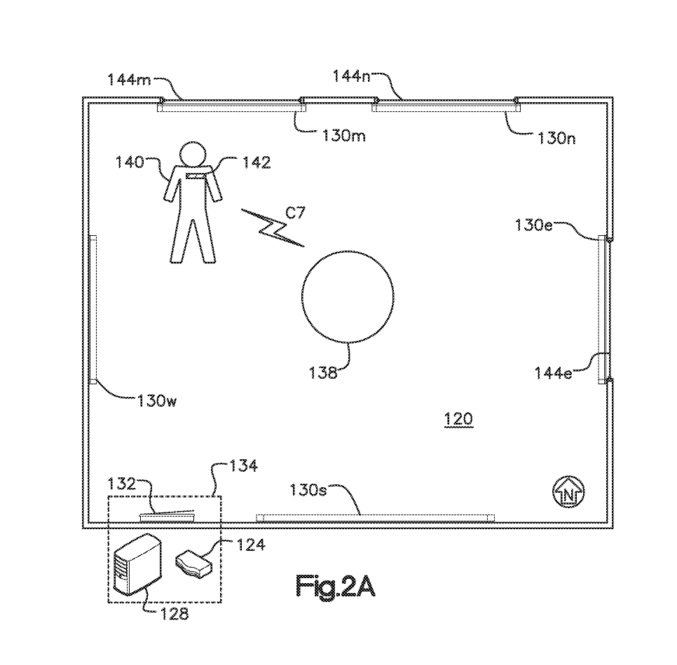

FIGS. 2A and 2B illustrate a schematic diagram of a top view of a local site 120 and a schematic diagram of a perspective view of a further local site 120, respectively. As shown, display devices 130 may be mounted on one or more windows or walls of a room. In FIG. 2A, a local site 120 has three windows: two windows 144m and 144n on the north side and one window 144e on the east side. Three display devices 130m, 130n and 130e are mounted over each of the three windows 144n, 144m and 144e. Two other display devices 130w and 130s are mounted over walls of the room 120 that do not have windows. In addition to the display devices 130, the display system of the local site 120 further includes a processor 128, a router 124 and a user interface 132, all shown schematically in FIG. 2A (with communication lines omitted). The component system 134 may be entirely integrated or it may comprise separately housed components. As shown, the processor 128 and router 124 may be mounted out of view (e.g., behind a wall) while the user interface may be mounted on the inside of a wall for access by a user 140. The local site 120 may further comprise a transceiver 138 and electronic tag 142, as will be described in greater detail below.

The display devices 130 may further comprise interactive features, such as a touch-screen, knobs, buttons, or control panel to provide additional capability as described further below or as would be recognized by one skilled in the art. Speakers 150 may be mounted or integrally installed on the display devices for the amplification of audio signals. As can be appreciated by one of ordinary skill in the art, the display devices may be installed over an existing window or be mounted on a wall or other object. If the device is installed over a window, it may further be configured to be hinge-mounted so that it can be rotated out from a position obstructing the window. To the extent that a surface of the display device is exposed to sunlight, solar panels may be installed to generate power for the system as can be appreciated by one of ordinary skill in the art. The entire display system, including the component system 134, may be located at the local site, which may have the advantage of minimizing data traffic across long distances.

The display devices 130 may have a flat screen structure and, optionally, may be further provided with 3D and/or high definition (HD) capabilities. The display devices 130 may be mounted on a grid fixed backing 152 that may have upgradeable processing units 154 that can be replaced over time to enhance the view and overall experience of the display device 130. Such modular upgradeable features allow consumers to upgrade the display device 130 without having to replace the entire display system. Using upgradable processing units allows users to be able to keep their basic framework while still updating the system. The display device may also be upgradeable as well by changing any speaker(s) 150 or other components mounted thereon.

As can be appreciated by one of ordinary skill in the art, the backing of the display devices may be an airtight fitted control hatch which can serve as a coolant system for the display devices which may be powered by the solar panels, if installed, whenever there is available light. Additionally, the display system can utilize a plurality of possible cameras on the outside and/or may provide a suitable field of view outside the room and also serve as a surveillance unit for building security.

FIG. 2B shows a perspective view of a further local site 120 which has window 144p on the north side and window 144z on the west side. Two display devices 130p and 130z are mounted over windows 144p and 144z, respectively, and a third display device 130s is mounted on the east wall of the local site. As can be seen in FIG. 2B, an interior illustration of the back side of display device 130z(with solar panels/cover removed) before installation into window 144z is shown to appreciate the grid fixed backing 152 that can accommodate upgradable processing units 154. Display device 130z includes a plurality of removable and/or upgradeable application units 154 that can be removed and replaced for repair or to provide upgraded performance without replacing the entire display device 130. Thus, for example, an improved camera or an improved processing unit or display element can be inserted without replacing the entire display device.

In other embodiments, the processing and/or configuration components of the display system may be located at the remote site or at a separate location apart from both the remote site and the local site. In this manner, the processing and/or configuration of the source data to output the refined data can be carried out by, for example, a designated facility that is equipped to handle large scale data processing and transmit the refined data to the local site for directly displaying the images without (or with minimal) further processing. This arrangement may provide the advantage of reducing the local site equipment costs and/or space requirements. The invention described herein will make reference to the processing and/or configuration components as being located at the local site 120, but it is appreciated that such components can alternatively or additionally reside at the remote site 110 or at any other location that may act as an intermediary between the remote site 110 and the local site 120.

In accordance with an aspect of the present invention, the display system provides an enhanced environment, for example, improving the living space of a user. In this manner, the invention may be distinguished from a conventional virtual reality immersion system in which the entire user environment is a virtual world. This unique character of the present invention lends itself to novel features relating to the placement and behavior of displayed images that are not found in conventional systems.

In accordance with an embodiment of the present invention, a display system includes processing components, a control system, and one or more display devices, for example monitors or screens, placed in various locations in a room at the local site. Preferably, the display system includes at least two display devices for enhanced user-experience, and may include up to four or five, or more if desired. The display devices 130 can have any number of components to enhance the user's experience as can be appreciated by one of ordinary skill in the art. For instance, as can be seen in FIG. 2B, display device 130p has speaker 150 and interior cameras 162. As discussed above, these components can be replaced or upgraded as the user's need arises so as to make the display devices scalable and upgradable without having to replace the entire display device itself. The display devices receive the refined data from the processing components and display the images represented thereby. The refined data may be transmitted from the processing components to the display devices by wireless or wired communications. Typically, the display devices may also have processing units 156 and/or infrared antennas 160 that will allow the display device to receive and process the transmitted data. For example, the refined data may be transmitted by radio frequency (RF), including short-distance RF (e.g., Bluetooth™), infrared, Wi-Fi, or the like, or by any known wired configurations known in the art, such as fiber-optic cable or standard cable or hereafter developed technology. The display devices may also have radio receivers 158 to communicate with transceiver 138 and help monitor a user's movement at the site 120 as will be discussed in more detail below.

As described above, the processing components process the source data according to a programmed scheme. It is contemplated that the present invention may comprise any number of possible schemes that dictate precisely how the source data is processed for display, as will be described below.

Scheme 1: Passive Display Based on Direction

In a first scheme embodiment, the refined data comprises one or more directional views that are extracted from a full field of view represented by source data. One directional view may be provided for each display device installed at a local site 120. For example, the source data may represent a full hemispherical field of view captured at the remote location 110, and the refined data may represent one directional view extracted from the hemispherical field in the north direction and one directional view extracted from the hemispherical field in the east direction. The size of the directional view may be configured to correspond to a view that would be framed by a hypothetical window of a building located at the remote location 110, with a hypothetical viewer in the building positioned at a predetermined distance from a window. The processing components are configured to manipulate the source data to create this refined data by digital processing as can be appreciated by one of ordinary skill in the art. The parameters such as size of the hypothetical window and position of the hypothetical viewer may be pre-programmed or specified by a user, along with any other desired parameters, such as zoom, special lens, or heat sensing, for example.

The example of one directional view to the north and one directional view to the east may be particularly suited for a room at a local site 110 having two windows on perpendicular adjacent walls, or simply a room having two perpendicular walls. Each window or wall may have a display device 130 mounted thereon. The refined data including these two views may then be transmitted to the display devices 130, one view for each device, so that a viewer positioned in the room may view the display devices displaying the images to give the effect that the room is located at the remote site where the images were captured.

Scheme 2: Active Display Based on Perspective of Viewer

In a second scheme embodiment of the present invention, the scheme described above as Scheme 1 is modified to be real-time dependent upon the position of the viewer in the room at the local site. The display system in Scheme 2 may further comprise a viewer position detector mounted at a strategic location in the viewing room for determining the position of the viewer relative to each of the display devices.

According to one embodiment, the position detector may comprise a centrally located infrared transmitter 138 that, in conjunction with infrared receivers mounted at various locations around the room, can determine the location of a viewer 140 by analyzing the signal interference. The position detector may also transmit individual radio wave signals to be collected by other receivers 158 that are mounted on the display devices or otherwise throughout the site 120. All of this information may then be analyzed by processor 128 or other components of the display system and the combined charts of radio shadow and infrared shadow can preferably blueprint the room layout.

Because the position detector is able to continually monitor the room, it is also capable of providing a security/occupant safety function as an alarm system in case of fire or intrusion, for example. In the preferred embodiment, the controller stores a wave blueprint (e.g., infrared fingerprint) of the room and compares the stored room signature to the condition sensed to determine what, if any, changes have occurred. This allows the detector to ascertain movement and detect a sudden change in environment that might indicate a fire, for example. By using sufficiently sensitive sensors, the controller could measure occupant body temperature and, in one embodiment, notify the occupant if their body temperature has changed above a certain threshold and emit an audible or visual message such as, “you seem to have a slight a fever.” Likewise, the detector could monitor occupant heartbeats (heart rate) and provide an alarm or initiate a call for help if an unsafe condition (e.g., heart attack) occurs.

An alternative location sensing technology is pressure-sensitive floor sensors. The flooring could be provided with multiple pressure sensors to measure the occupant's position, movement, center of balance and body mass as would be appreciated by one of ordinary skill in the art and as is currently used in certain virtual reality systems or games.

In accordance with a further embodiment of a viewer position detector, the viewer may have a dedicated electronic device 142 attached to his or her person or clothing for communicating, via communication means C7, with one or more transmitters and/or receivers 138 located in the viewing room, as shown in FIG. 2A. A transceiver device 138 may have directional and proximity detection features to determine the precise location of a viewer 140 in the room. The transceiver 138 may then provide this information to the processor 128, which in turn processes the source data and outputs refined data to each of the display devices 130 to reflect a change in perspective of the viewer 140. The images displayed on the display devices 130 preferably change in accordance with what a viewer would be seeing out of windows of a room located at the remote site 110, with each display device 130 representing such a window. As can be appreciated by one of ordinary skill in the art, various technologies including RFID can be used to track or monitor the movement of user 140 in and around local site 120.

From room temperature to airflow, every aspect of the room may be recorded or monitored through a viewer position detector or other monitoring device. Therefore, if there is any change that a user may want to be alerted to, either fire or break-ins, the monitors may provide an alert. Highly specialized sensors may also be installed, such as moisture or air pressure sensors. Between the individual sensors the slightest change in any area of the room from moisture collecting in a corner to the evaporation of water from a potted plant.

The sensors also allow the position detector to map a viewer's position in the room and adjust the image to his or her relative perspective.

All the information gathered may be collected by variations of “stream line patterns” according to the Fibonacci sequence which can assist in reconstructing the transmitted image, as well as sounds and/or sublevel disturbances. The information may likewise be routed to a central server which can also be connected to the heating and air conditioning control panels and the alarm systems of the building.

Each monitor or display device may have separate cameras, interior cameras 162, facing the inside of the room as well as cameras outside, if attached to a true window. These cameras may then serve the double function of also acting as the home monitoring system. A user may also utilize interior cameras 162 to record events occurring within the room, such as parties or dinners, and save the moments, the view and the feeling.

The system may also allow a user to monitor a building from remote locations. The server may relay all transmissions to a predetermined location. Cameras via cable, satellite, fiber optics or whatever means of transmission becomes available.

Without limiting the invention or wishing to be bound by theory, the recording of information through the Fibonacci sequence may allow the image collector to reconstruct the image according to the natural flow and process of the wave/particle phenomenon which breaks down every part of the image and assigns individual values to the composites of said image at proportional speeds and frequencies. When collected and enhanced according to its specific patterns, each portion can be integrated into any other for a perfect fit for the viewer at home or in the office through the monitor control unit and touch screen appliances.

The Fibonacci sequence may be the common frame of reference for all applications. This recreates the moment as realistic as possible and allow all the units to be integrated to a central station where they are routed to individual home servers and then into each display system in each room.

Once the viewer's position is determined, the central control unit of the display system instructs the processing unit to process the received data in such a way as to result in video feeds corresponding to the perspective of the viewer with respect to a hypothetical window at the remote site 110 where the images are being or have been captured or collected. In other words, the images displayed on the display devices 130 change depending on the location of a viewer in the room so that the viewer is provided with the illusion that the room is located at the remote site 110.

The processing necessary to achieve this effect takes into account the viewing angle of the viewer relative to each display device and to the resulting view on, for example, a hemispherical field of view of the remote site provided by the source data. With the source data representing every possible view being input to the processors, the specific calculation to determine an appropriate extracted “window” view based on a view angle and predetermined window size parameter would be recognized and appreciated by one skilled in the art, although any heretofore known or hereafter developed processing schemes may be used without departing from the scope of the invention.

Scheme 3: Interactive Display Control Unit

In one embodiment according to a third scheme, the control unit coordinates the various functions of the display system, including source data reception and processing, and the output of refined data to the one or more display devices. The control unit may further have a user interface 132 in order to receive specific commands, preferences, or other inputs from a user. The control unit may have storage for storing electronic data, which can represent recorded images received from the remote site, downloadable content, preprogrammed content, or the like. A user may instruct the control unit via the user interface 132 to display any desired images, whether live video stream, stored content, or a combination of the two. The user interface 132 may be any suitable human-interaction device such as a touch-screen interface, buttons (hard or soft; i.e., designated function buttons or context-sensitive), knobs, or the like. The control unit may also be controlled by a remote control communicating with the unit by infrared or RF signals or other control devices as would be appreciated by one of ordinary skill in the art.

In an embodiment, the display system control unit may comprise cylindrical units connected to each other like cartridges. Each cartridge may be a separate function module that provides specific tasks or capabilities to the display system, for example, each cartridge may be a designated radio wave processing unit, infrared wave processing unit, picture orientation unit, touch screen unit, or home monitoring unit. Cartridges may further be configured to provide for the ability to use the display system either as a simple television, a computer screen, or a remote transmission viewing device as described herein. Each cartridge may be a means to update the display system as the technology allows without having to replace the control unit in its entirety. Similarly, the processing units 156 may comprise cartridges 170 that can be replaced or upgraded to enhance the processing unit's 156 capabilities without replacing the entire display device 130. In one embodiment, the display system control unit and/or some of its functionality may be incorporated into or combined with the processing unit 156.

An array of antennas, whether internal or external, may be disposed at various locations of the control unit, processors, and/or display devices. These antennae may assist in collecting and transmitting data. Some of these are shown in FIG. 2B.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents. In this regard, any number of the features of the different schemes of embodiments described herein may be combined into a single embodiment. Moreover, the scope of the present invention is intended to cover all conventionally known and future developed variations and modifications as would be understood by one of ordinary skill in the art.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention. It is also to be understood that the following claims are intended to cover all of the generic and specific features of the invention herein described and all statements of the scope of the invention which, as a matter of language, might be said to fall therebetween.

What is claimed is:

1. A system of merging virtual reality sensory detail into a room environment at a local site the system comprising:
at least one image server;
a plurality of image collection devices;
a display system, the display system comprising:
one or more display devices;
a control unit,
a digital processor; and
a viewer position detector, the viewer position detector configured to determine a position of an occupant at the local site relative to the one or more display devices, and to electronically communicate the viewer position information to the control unit;
wherein the control unit is configured to receive the viewer position information and transmit instructions to the digital processor in accordance with a predetermined display scheme; the digital processor is configured to receive the instructions from the control unit, and to receive, from the image server, source data representing an aggregated field of view captured by the plurality of image capturing devices, and the digital processor is further configured to process the source data in accordance with the instructions received from the control unit and to output refined data representing a desired display view and the one or more display devices are configured to receive the refined data, and display the desired display view; and
wherein the viewer position detector dynamically determines the position of the viewer in the room environment and, upon transmission of the viewer position information to the control unit, the control unit instructs the digital processor to process the source data to produce refined data that represents changes to the desired display view corresponding to position changes of the viewer.

2. The system of claim 1 wherein at least one of the display device is placed over an existing window at the local site.

3. The system of claim 1 wherein the viewer position detector comprises an RFID component.

4. The system of claim 1 wherein the display system further comprises a user interface device that is configured to receive data from a viewer and transmit that data to the control unit to affect changes to the predetermined display scheme.

5. The system of claim 1 wherein the display device further comprises speakers.

6. The system of claim 1 wherein the control unit has interchangeable components.

7. The system of claim 1 wherein the display device further comprises solar panels to power the display device.

8. The system of claim 1 wherein the plurality of image collection devices are part of a panoramic imaging system.

9. The system of claim 1 wherein the display device is an organic light emitting diode display.

10. The system of claim 1 wherein the at least on of the display devices is mounted on a grid fixed backing that is configured to allow the replacement of components of the display devices.

11. A system of merging virtual reality sensory detail from a remote site into a room environment at a local site, the system comprising:
at least one image collection device configured to collect a plurality of image streams from a remote site, the image streams comprising images and related data;
a processor configured to receive the image streams via a communications link from the at least one image collection device and processing said related data;
a viewer position detecting device;
a display controller configured to receive data from the viewer position detecting device, and the processed data from the processor;
a first display device located at the local site; and
wherein the display controller causes the first display device to show images from a particular image stream from the plurality of image streams based upon the data received from the occupant position sensing device and the processed data.

12. The system of claim 11 wherein at least one of the display device is placed over an existing window at the local site.

13. The system of claim 11 further comprising a second display device wherein the display controller causes the second display device to show images from a different image stream than the first display device so that the images shown by the first display device conform in some manner with the images shown by the second display device.

14. The system of claim 11 wherein the display system further comprises a user interface device that is configured to receive data from a viewer and transmit that data to the display controller to affect the images shown on the first display device.

15. The system of claim 11 wherein the display device further comprises speakers.

16. The system of claim 11 wherein the display controller has interchangeable components.

17. The system of claim 11 wherein the at least on of the display devices is mounted on a grid fixed backing that is configured to allow the replacement of components of the display devices.

18. A method of merging virtual reality sensory detail from a remote site into a room environment at a local site, the method comprising:
collecting a plurality of image streams from a remote site;
sending the plurality of images and related data to a processor via a communications link;
processing the related data to represent an aggregated field of view of at least a portion of the remote site;
receiving the processed data from the processor via a communications link at a display controller device;
monitoring a viewer position detector to track the location of an occupant at the local site;
transmitting data related to the location of the occupant to the display controller device;
determining an appropriate image stream based on the processed data and the transmitted data;
transmitting instructions to a digital processor to output refined data from the plurality of image streams representing a desired display view; and
displaying the desired display view on one or more display devices at the local site.

19. The method of claim 18 further comprising: inputting additional data at a user interface to represent additional preferences of the occupant in displaying the desired display view.
